(19) United States
(12) Patent Application Publication
(10) Pub. No.: US 2014/0071478 A1
(43) Pub. Date: Mar. 13, 2014

(54) CLOUD-BASED CREDENTIAL PERSONALIZATION AND ACTIVATION SYSTEM

(71) Applicants: Phillip G. King, Madison, MS (US); James Christian Eaton, Long Beach, MS (US); Jon Delozier, Long Beach, MS (US); Lindsay Martin-Nez, Vicksburg, MS (US)

(72) Inventors: Phillip G. King, Madison, MS (US); James Christian Eaton, Long Beach, MS (US); Jon Delozier, Long Beach, MS (US); Lindsay Martin-Nez, Vicksburg, MS (US)

(73) Assignee: BADGEPASS, INC., Ridgeland, MS (US)

(21) Appl. No.: 14/023,088

(22) Filed: Sep. 10, 2013

Related U.S. Application Data
(60) Provisional application No. 61/698,796, filed on Sep. 10, 2012.

(51) Int. Cl. G06K 15/00

(52) U.S. Cl. CPC G06K 15/4095
USPC 358/1.14

(57) ABSTRACT

We disclose herein a system and method to submit, personalize and activate a physical identity credential via the internet. This product is a new process and an improvement over existing products that either allow a user to (a) submit data and photos to an online service to personalize a physical identity credential or (b) utilize installed software to personalize and activate a physical identity credential by utilizing a local or network printing device.

### CROSS-REFERENCES TO RELATED APPLICATIONS

This application claims priority to U.S. Provisional Application No. 61/698,796 filed on Sep. 10, 2012, which is hereby incorporated by reference in its entirety.

### FIELD OF THE INVENTION

The present invention is generally directed toward a cloud-based credential personalization and activation system.

### BACKGROUND OF THE INVENTION

Identity credentials are most commonly encoded with a unique technology number by a credential authority and then sold to employers and organizations to be personalized by a card printer. They are then activated and associated with a credential-holder within a credential automation application, such as a physical access application, logical access application, electronic time clock application or electronic tracking application. Employers or organizations with fewer than one hundred entities typically have a hard time justifying the capital expense of a card printer to personalize credentials but would benefit from having a personalized credential activated in one of these applications to control physical access to doors, have logical access to network resources, automate the collection of work hours, and track and report specific activities.

As a result, these smaller employers and organizations generally resort to third-party printing services to personalize the credential and a manual process to activate the credential and associate it with a credential-holder in the automation applications. Using this process increases the risk of data entry errors that can cause inaccurate reports and could grant potentially inappropriate access to confidential information.

### SUMMARY OF THE INVENTION

We disclose herein a system and method to submit, personalize and activate a physical identity credential via the Internet. This product employs a new process and is an improvement over existing products that allow a user to either (a) submit data and photos to an online service to personalize a physical identity credential or (b) utilize installed software to personalize and activate a physical identity credential by utilizing a local or network printing device.

The claimed device allows a user to submit data and photos to an online service to personalize a physical identity credential and also automate the process by automatically activating the unique technology numbers in applications that use the numbers and credential-holder information via the Internet.

In one embodiment, the customer is provided installed software that collects personal information and photos, submits the print job over the Internet to a printing service, and, then collects the card technology unique numbers for automatic insertion with the personal credential-holder's record after the credential is printed. In addition, that unique credential number can be automatically loaded into an access control.

### BRIEF DESCRIPTION OF THE DRAWINGS

Further advantages of the invention will become apparent by reference to the detailed description of preferred embodiments when considered in conjunction with the drawing:

FIG. 1 depicts a preferred embodiment of the claimed invention.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

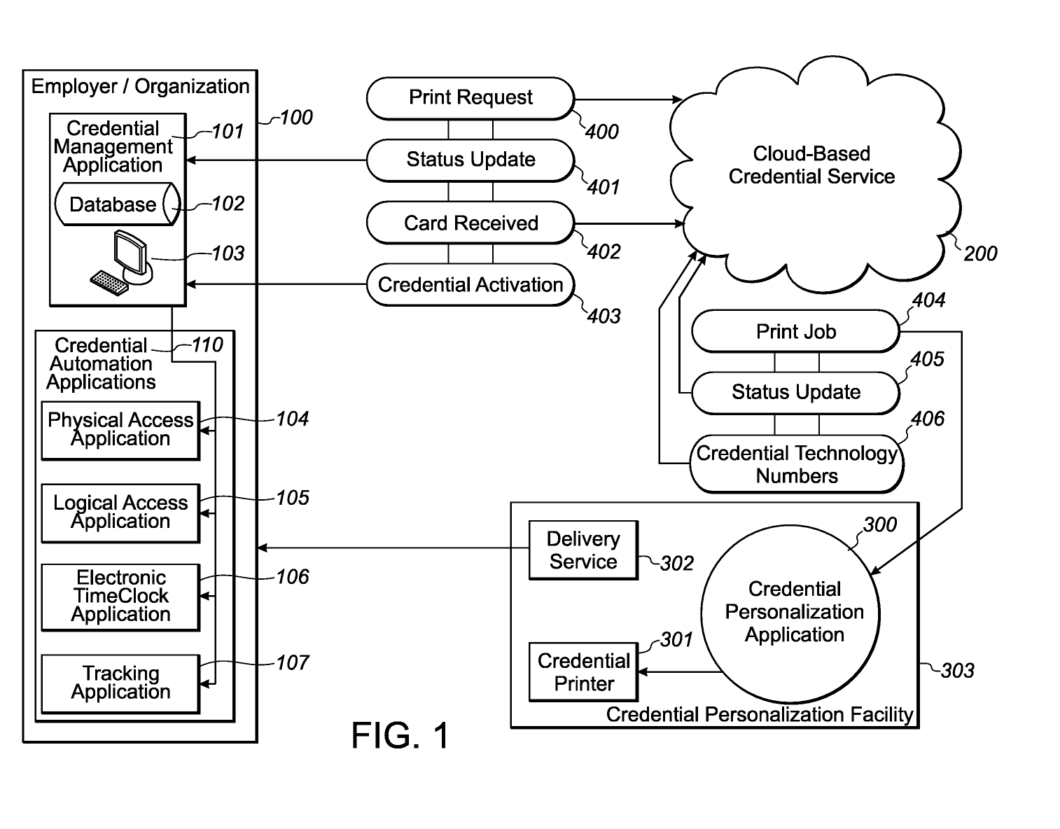

Referring to the drawings, FIG. 1 illustrates an exemplary embodiment of the cloud-based credential personalization and activation system. The system generally includes a cloud-based credential service 200, one or more credential personalization facilities 303 that consist of one or more credential personalization applications 300, and one or more employers/organizations 100 that consist of one or more credential management applications 101 and one or more credential automation applications 110.

### Credential Management Application

All necessary data needed to personalize the credential is collected by the employer/organization 100 through a credential management application 101 that consists of a database 102 and software that has the capability to capture a live photo 103. Other embodiments allow for importing images (photos) from file, either from the Internet, digital media, or imported from electronic scans (image and data) of government issued identifications (e.g., state issued Driver's Licenses or federal issued documents). The credential management application 101 is responsible for sending print requests 400 to the cloud-based credential service 200 as well as notifying the cloud-based credential service 200 when physical credentials have been received 402. In addition, the credential management application 101 is responsible for checking in with the cloud-based credential service 200 on periodic bases to receive any current status updates 401. After receiving a credential activation message 403, the credential management application 101 is also responsible for activating the credential and associating it with a credential-holder in one or more of the credential automation applications 110.

### Cloud-Based Credential Service

The cloud-based credential service 200 is generally responsible for queuing print requests 400 from credential management applications 101, passing print jobs 404 to a credential personalization application 300, propagating status updates 405 from a credential personalization application 300 to the appropriate credential management application 101 via status update messages 401, storing unique credential technology numbers 406 received from a credential personalization application 300, and responding back to credential management application 101 card received messages 402 with a credential activation message 403 containing one or more unique credential technology numbers.

### Credential Personalization Application

Credentials are personalized by a credential personalization facility 303 through a credential personalization application 300, generally responsible for personalizing the credential through a credential printer 301, notifying the cloud-based credential service 200 of any status updates 405, and passing back one or more unique credential technology numbers 406 to the cloud-based credential service 200 once the print job 404 is completed.

### Delivery

Credentials are physically delivered to employers/organizations 100 via a delivery service 302 utilized by a credential personalization facility 303.

### Credential Automation Applications

The disclosed invention also comprises Credential Automation Applications 110 that provide a variety of features associated with credentials and credential-holders. An employer/organization 100 may use credentials to grant and/or restrict physical access to facilities or a portion(s) of a facility for one or more credential-holder(s). Such physical access can be granted, restricted, and/or managed by a Physical Access Application 104. Access to software applications, databases, computing equipment, and the like may also be critical for an employer/organization 100. Such logical access can be granted, restricted, and/or managed by a Logical Access Application 105.

A Tracking Application 107 may also be associated with credentials. A Tracking Application 107 provides for monitoring and tracking credential-holders in a facility. Tracking can be real-time and/or historical data, and it can provide information for every credential-associated event occurring at the facility at any given time. Such data may include employee and visitor traffic through access points, date and time of events, etc. Preferably, the Tracking Application 107 is web-based and includes a capability for running reports for every credential-associated event occurring at the facility at any given time. Reports can be configured to be sent via email or other suitable delivery means to an appropriate security or managing personnel of employer/organization 100 if a preset event occurs or if a door remains open for longer than a preset time.

An employer/organization 100 may also add a magstripe, 2D barcode, or similar feature to a credential to allow for a credential-holder to clock in and clock out using their credential and appropriate hardware, such as scanners, readers, personal computing devices, and the like. Such feature is managed by an Electronic TimeClock Application 106. Preferably, the Electronic TimeClock Application 106 is usable with third party software and hardware for managing employee time. An Electronic TimeClock Application 106 feature can also allow for an employee manager to access the employee time data in a web-based application for supervising, managing, and/or approving time sheets of employees at the end of pay periods.

### Working Example 1

Customer ABC is a 50 employee firm in Memphis, Tennessee and wants to enable their individual doors with keyless card access control. Customer ABC wants to use their issued employee ID Cards to allow access for the doors and have a full audit log of activity. Customer ABC does not want to purchase a system to personalize the IDs due to the fact that a typical system is three thousand dollars, roughly sixty dollars per employee.

To solve the problem, a user of the claimed product would install software, database, access control panels and door locks at customer ABC's location. Customer ABC would then submit personalization requests over the Internet to the BadgePass printing service. The user would print the physical identity credential, collect the unique technology numbers, ship the credentials to customer ABC and automatically insert the credential technology numbers when customer ABC confirms the arrival of the physical ID Cards.

It is further contemplated that, in addition to the existing scenario, hosted access control and time companies that have a software as a service model may use a similar system that would allow a company to submit personalization requests to an online printing service and then load the unique technology numbers into an online database, as well as push those back down into access control panels and time clocks locally. Also, access control and or time companies could use a system as disclosed herein to allow larger customers that do high volumes of card personalization for use in their locally installed systems to order physical credentials and have those automatically loaded into their system locally as they are shipped.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A system for managing credential-bearing identifications comprising:
(a) a credential management application installed on a customer's computer;
(b) a web hosted credential service to manage a print job; and
(c) a credential personalization application at a printing facility to print a physical credential and collect one or more unique technology number to be pushed back into the credential management application installed on the customer's computer.

2. The system of claim 1, wherein said credential management application installed on a customer's computer comprises a database and software capable of capturing a live photograph of a prospective credential-holder.

3. The system of claim 1, wherein said credential management application installed on a customer's computer comprises a database and software capable of importing a stored photograph of a prospective credential-holder.

4. The system of claim 1, wherein said credential management application installed on a customer's computer is capable of communicating a print request to said web hosted credential service.

5. The system of claim 4, wherein said credential management application installed on a customer's computer is capable of communicating to said web hosted credential service when said physical credential is received by the customer.

6. The system of claim 6, wherein said credential management application installed on a customer's computer comprises at least one credential automation application.

7. The system of claim 6, wherein said at least one credential automation application is selected from the group consisting of a physical access application, a logical access application, an electronic timeclock application, and a tracking application.

8. The system of claim 6, wherein said credential management application installed on a customer's computer is capable of activating said physical credential and further associating said physical credential with said prospective credential-holder in said at least one credential automation application.

9. The system of claim 8, wherein said credential management application installed on a customer's computer is capable of periodically communicating to said web hosted credential service to request a current status update of a credential.

10. The system of claim 1, wherein said web hosted credential service comprises software for queuing more than one print job received from more than one customer.

11. The system of claim 10, wherein said web hosted credential service is capable of communicating said print job to said credential personalization application.

12. The system of claim 11, wherein said web hosted credential service is capable of communicating a current status update of a credential to said credential management application installed on a customer's computer.

13. The system of claim 12, wherein said web hosted credential service further comprises a storage element for storing at least one unique credential technology number and further comprising a communication element for communicating said at least one unique credential technology number to said credential management application installed on a customer's computer.

14. A method for managing credential-bearing identifications comprising:
receiving a print job request for a physical credential from a credential management application installed on a customer's computer by a web hosted credential service;
sending a print job order from said web hosted credential service to a credential personalization application at a printing facility to print said physical credential;
receiving at least one unique credential technology number from said credential personalization application;
storing said at least one unique credential technology number from said credential personalization application;
receiving a physical credential received message from said credential management application installed on a customer's computer; and
sending a credential activation message containing said at least one unique credential technology number to said credential management application installed on a customer's computer.

15. The method of claim 14, further comprising receiving status updates from said credential management application and sending said status updates to said credential management application installed on a customer's computer.
